(19) United States
(12) Patent Application Publication
(10) Pub. No.: US 2007/0294725 A1
(43) Pub. Date: Dec. 20, 2007

(54) MESSAGE-TO-WAP LINK FOR CONTENT AND ADVERTISING

(76) Inventors: Grant Cohen, Irvine, CA (US); Daniel Smith, Irvine, CA (US); Walter Kostiuk, Irvine, CA (US)

Correspondence Address: Daniel M. Gurfinkel, 120 South Riverside Plaza, 22nd Floor, Chicago, IL, 60606-1500, US

(21) Appl. No.: 11/758,434

(22) Filed: Jun. 5, 2007

Related U.S. Application Data
(60) Provisional application No. 60/810,896, filed on Jun. 5, 2006.

(51) Int. Cl. G06F 3/00

(52) U.S. Cl. 725/37

(57) ABSTRACT

A system for enhancing advertising revenue in a mobile communications environment includes a mobile communications device having a display screen and a wireless Internet enabled interface configured to facilitate the display of graphics on the display screen, and a natural language search service configured to receive a query from a user via the mobile device in natural language with service returning the direct answer and not links. In response to a user query from a mobile device the search service returns an appropriate response to the user via the mobile device. The response integrates an answer to the user's query with relevant advertisements in a single or same display image. The advertisements can include graphic and/or multimedia information; the presentation of such graphic information to the user, together with the unique targeting of ads to answers on the display screen, supports high CPM (cost per thousand views) as desired by advertisers sponsoring the advertisement.

### CROSS-REFERENCE TO RELATED APPLICATIONS

This application claims the benefit of priority from copending provisional patent application Ser. No. 60/810,896, filed on Jun. 5, 2006, entitled Message-To-WAP Link For Content And Advertising. Application Ser. No. 60/810,896 is hereby incorporated by reference in its entirety.

### FIELD OF THE INVENTION

The present invention relates generally to a method and apparatus for facilitating e-commerce and more specifically to a method and apparatus for integrating responses to user requests along with relevant advertising on wireless Internet-enabled mobile communication devices.

### BACKGROUND

Generating mobile advertisement revenue from mobile phones and other mobile devices such as personal digital assistants (PDA), Blackberry® type devices and others, has to date been limited by a number of factors. Traditionally, marketers pay service providers and Internet websites, such as Google® and others, every time their specific ad is placed in view of an interested user. Billing for such advertisements is called CPM or ‘cost per thousand’ referring to the cost to the advertiser per 1000 views on the advertisement by users of the service. These users enter keywords into search engines that connect the searched criteria with the associated advertisement. Such searches are common on Internet browsers, but have led to somewhat unsatisfactory results in limited access situations such as with mobile telephone usage. The mobile telephone provides a challenge for all search engines and websites that are trying to generate significant ad revenue from mobile users similarly to what is experienced with online trademark Internet use.

Users of mobile telephone devices currently have the ability to search for and acquire information, such as, stock quotes, weather, sports information, trivia, ringtones, TV/movie clips and the like through mobile browser applications and menu driven client applications, directly from their mobile device. There are several drawbacks for these mobile telephone users associated with the current modes of searching for and acquiring this information. Currently mobile telephone users are typically relegated to the difficult and cumbersome navigation of existing mobile web browsers. Search on mobile telephones can usually be performed via browser search using WAP (Wireless Access Protocol) or other mobile wireless Internet access technology where the mobile user receives countless links to possible websites that may or may not contain all or part of the answer for which the user was searching. This is commonly described as “surfing in the online world.” This is not entirely feasible on a mobile phone due to the many limitations related to the inherent small screens on mobile telephones as well as limited keyboards and also comparatively slow wireless networks (as compared to high speed land lines).

The recent use of mobile widgets technology used to display multiple screens of content at one time on a cell phone is one method of placing a greater amount of content and information on a mobile telephone, but is still limited by the same weaknesses described above. Placing more information on a limited user interface is not the answer for mobile telephone Internet searching.

Other systems such as those that use leverage SMS (short message service) or email, (depending upon the device and the user's preferences) are burdened by generally receiving very limited information in plain text.

With the expansion of search capabilities on computers and the rapid growth of search demand on mobile devices, it is important to provide users with a better way to access the information they desire directly from their mobile device. Further, it is very important that the mobile search providers be able to easily deliver the desired information with the supporting marketing messages and advertisements such that advertising revenues that support such services can be made and such services can continue.

One problem with current SMS search on mobile devices is the lack of the ability to show a full answer, which may be too long to show in SMS format since SMS allows for a maximum of up to 160 characters per SMS message. This raises a secondary problem, where in order to view more information on your search, you need more SMS messages which can be costly and frustrating to navigate through as there is no guarantee the messages will arrive in the order the provider sends them. Further, in some cases, when using language from a content source, if the entire text message is not displayed problems may arise because in some situations a truncated display may be considered to be altering the content, which may be a violation of certain third-party rights.

For this reason, advertising provided to users on mobile devices suffer from poor “click through rates.” The term “click through”, as used by a person having ordinary skill in the art, means when a user actual clicks on a link, or number within an SMS message causing the mobile browser to open and display an associated web page or alternately dialing directly to the marketer for order processing. Advertisers desire that users click through on their advertisement so as to view the advertisement, as they hope by doing so, such users may be motivated to purchase products. It has been found that very few users click through a mobile advertising originating from an SMS message or while searching through a mobile search engine. Users prefer to read an answer to their initial query and then close or delete the SMS message.

As a result of low click-though rates, advertisers are only willing to pay a low CPM (cost per thousand views) for such textual or mobile browser ad placements. Conversely, graphical advertisements have been found to generate the highest CPM from advertisers because such graphical advertisements are deemed to be more compelling to the user and are thought to be a better vehicle for capturing the user's attention and interest. However, the ability to motivate the cell phone user to “click through” and view a graphical advertisement is very poor at best due to the above-described drawbacks.

With respect to existing module device search services, SMS Search, for example, is provided by a variety of search companies, such as Google SMS and 4Info. These services search for and acquire information via formatted SMS questions and automatic SMS replies comprising information. However, SMS Search users and providers are greatly restricted because, as noted before, the messages are limited to 160 characters in length (or even fewer from some carriers). In such an environment, messages cannot contain color, graphics, sound or other non-text multimedia. Such limitation prevents the user from receiving, and prevents search companies from providing, complete answers to any number of questions asked. Because “advertising-supported” has become the predominate revenue model for search engines (both online and on mobile phone) and because of the character and graphical constraints associated with mobile users, mobile search solutions are greatly limited in their growth potential due to the medium with which they provide information.

One response to the SMS search problem thus far has been for users to open a mobile web browser on their mobile phones and perform searches via the mobile web, similar to what would be done on a desktop computer. While this helps to solve the problem of delivering a low quality search reply and advertisement, it creates another problem because mobile web browsers are clumsy and inefficient, resulting in a very poor user experience. In such existing environments, the user must click through multiple links in a daisy-chain fashion, which quickly turns into a frustrating experience due to the delays incurred. Most mobile devices presently on the market are not designed to easily navigate from one web page to another. Because of this, searching through results and clicking through to the desired information and the supporting advertisements is inefficient and not a particularly enticing procedure for the end user. Accordingly, advertisers are not willing to pay a high CPM for such sponsored advertisements because of the low click-through rate by the end user.

Downloadable applications providing direct links to the desired information are also another partial solution offered to some users. However, much like mobile web browsers, most cellular telephones and/or other mobile devices on the market today do not allow for a simple or easily maneuverable user interface and do not typically offer access to a user asking for a broad range of queries. Additionally, these applications are difficult to install and are not built-in or pre-installed in most devices. Partial solutions to some of these issues have been deployed in the marketplace, but none address both searching for and acquiring of answers to queries by the end user and providing advertising to the end user in a mode that promotes high CPM, thereby providing the continued offering of such services to the users.

### SUMMARY

The disadvantages of present systems for providing advertising to mobile users may be substantially overcome by providing a novel system for presentation of content and advertising with a wireless Internet enabled mobile device. More specifically, in one embodiment, the system for enhancing advertising revenue in a mobile communications environment includes a mobile communications device having a display screen and a wireless Internet enabled interface (such as a cellular telephone) configured to facilitate the display of graphics on the display screen. The mobile device in such an application is used in conjunction with a search service configured to receive a query from a user via the mobile device, using, for example, methodology from AskMeNow Inc.'s, the assignee of the present invention, U.S. patent application Ser. No. 11/165,422, entitled WEB-BASED METHOD FOR RESPONDING TO USER QUERIES, or from Expert Systems patent application Ser. No. 11/744,479, entitled METHOD AND SYSTEM TO AUTOMATICALLY EXTRACT RELATIONS BETWEEN CONCEPTS IN A TEXT, also owned by the assignee herein, and both of which are incorporated herein by reference as though set here in their entity.

It will be understood by persons having ordinary skill in the art that other available methodologies can be incorporated herein, as available and compatible, without departing from the novel scope of the present invention. In the present invention in response to a user query, such search services provide a response to the user on the mobile device, where the response integrates an answer to the user query with relevant advertisements or advertising indicia in a single or the same display image. The advertising indicia may include graphic information, and such presentation of the graphic information to the user on the display screen supports a high CPM (cost per thousand views) paid by advertisers sponsoring the advertisement. By integrating the graphical advertisements within the answer to a user query, the highest revenue from advertisers are generated because it is likely that a user would click on a URL to view an answer to a searched question from their phone, resulting in a larger number of total banner impressions. Higher advertising rates also occur because the present invention provides question-and-answer accuracy greater than previously possible, allowing the appropriate advertisement to be placed in accordance with the particular category of questions. For example, if the user's mobile search question is “what is the price of a standard 50 inch plasma TV?” the answer would include a graphical ad from a television vendor, such as Best Buy or Circuit City, within the specific answer response screen. This greater relevance also increases the value of the CPM, while also increasing the click-through rate, which results in a greater total revenue when the advertisers is paying on a PPC (pay-per click) model.

The present system also permits the user to submit a search either by calling or messaging the search service via the customized natural language (NLP) technology, described in the above noted prior patent application (including SMS, Email, or IP connection, depending upon the device and the users preference), in one unique location, namely the mobile search solution or search service providing this service. The user can then receive the desired information returned to the query device via SMS, Email, Mobile Internet (like WAP), an IP connection or MMS, depending upon the device and the user's preference. The user receives the information as a single link that automatically or by choice opens the cell phone browser directly to a prepared mobile web page containing the information as well as supplemental advertisement, all in a multimedia format that can include graphics/images. Further, the answer to the query is not constrained by a fixed length or character count as the prior art. The unlimited character length here allows for a full answer (and site a source where necessary) to be shown, and eliminates the need to send and receive and view more than one SMS, email or mobile web page.

The subject invention provides for users with a variety of readily available ways to search for information using NLP technology, and then provides the desired information back to the end user in the richest possible format. The user obtains all of the benefits of searching the web and/or using an IP application, but eliminates the cumbersome user interface and long loading time associated with known systems. This permits the present search solution to provide information of a much higher quality, while generating far more revenue from advertisers who are eager to deliver much richer marketing messages and targeted offers to end users.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a block diagram of a specific embodiment of a customer query and answer system;

FIG. 2 is a block diagram of a specific embodiment of the system of FIG. 1;

FIG. 3 is a high level flowchart according to one embodiment of the invention of FIG. 1 illustrating handling of an incoming customer query;

FIG. 4 is a high level flowchart according to one embodiment of a method of the invention of FIG. 1 illustrating servicing of a customer query;

FIG. 5 is a high level pictorial diagram of a system according to the present invention;

FIG. 6 is a high level flow diagram of the system of FIG. 5; and

FIGS. 7 and 8 are pictorial displays of screen presentations of the system of FIG. 5.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

In this written description, the use of the disjunctive is intended to include the conjunctive. The use of definite or indefinite articles is not intended to indicate cardinality. In particular, a reference to “the” object or thing or “an” object or “a” thing is intended to also describe a plurality of such objects or things.

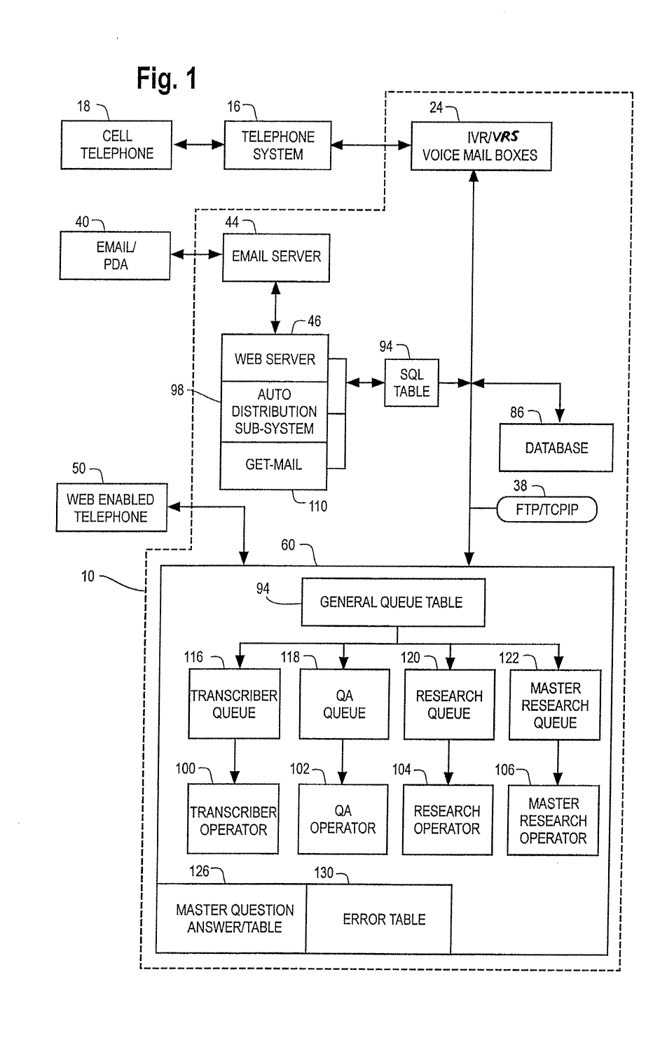

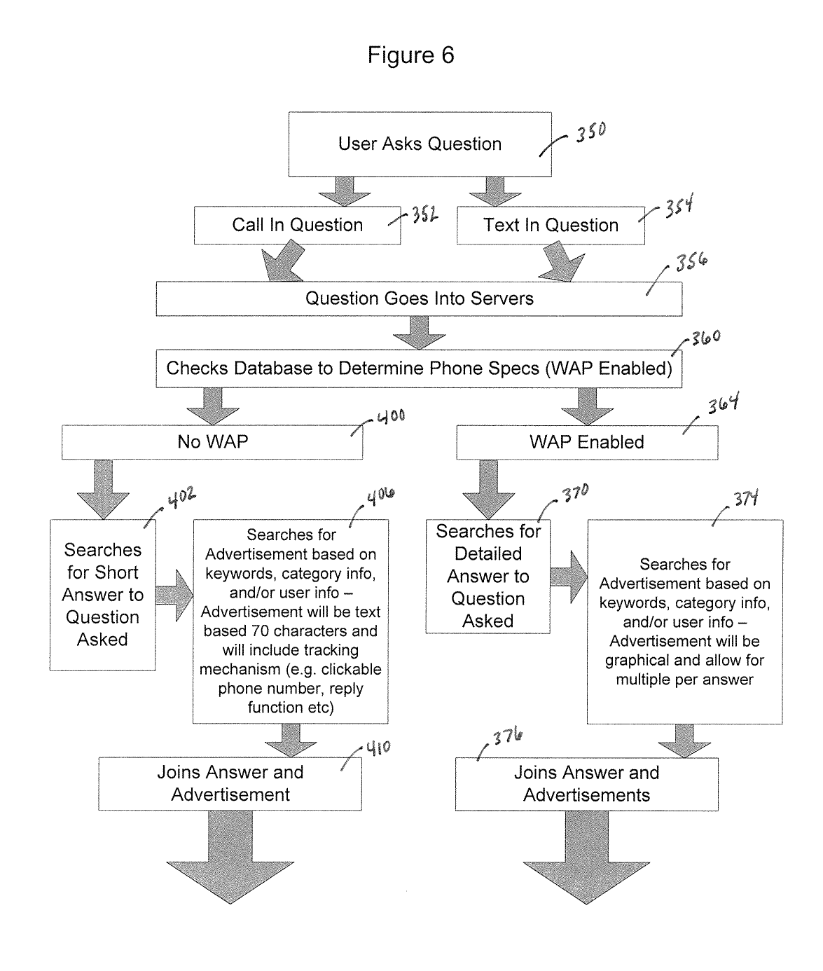

Referring now to FIGS. 1-4, a query and answer system 10 for responding to user queries is shown in a high-level block diagram. Note that FIGS. 1-4 are directed to the response service or search service that may be used in conjunction with the invention or embodiment of FIGS. 5-8.

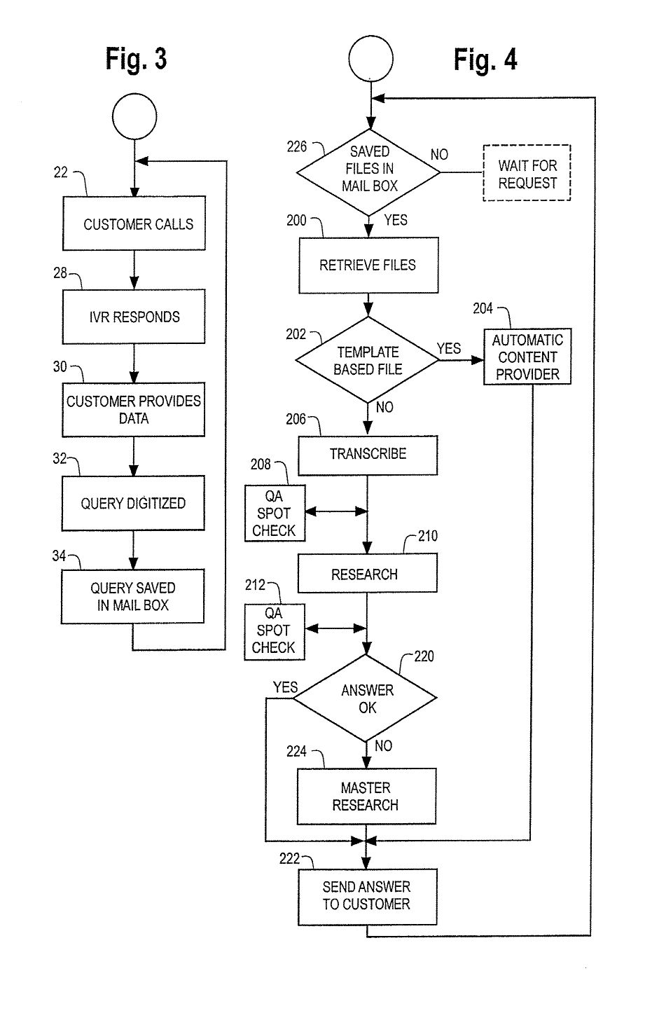

FIG. 3 is a high level flow chart illustrating certain actions by the customer and the system and will be referred to in this review of the query and answer system 10. A user or customer may communicate with an established telephone system 16 using either a land line or a cellular telephone 18 (see step 22, FIG. 3). An interactive voice response and/or voice recognition system (IVR/VRS) 24 device coupled to the telephone system 16 provides prompts to the caller (see step 28, FIG. 3), and the caller records a voice message or question (see step 30, FIG. 3), which is digitized and then stored by the IVR/VR (see steps 32 and 34, FIG. 3). The IVR/VR 24 is, in turn, operatively coupled to the query and answer system 10 via FTP (file transfer protocol) preferably using TCPIP protocol 38, as is known in the art.

The customer may also use a personal digital assistant (PDA) 40 or any suitable communication device or computer to send an email. Such devices preferably communicate with an email server 44, which may be, in turn, operatively coupled to a web-server 46. The web-server may be, in turn, operatively coupled to the query and answer system 10 via FTP as described above. Similarly, the email server 44 may provide prompts to the user or customer to provide certain information regarding his query.

Alternatively, the user may use a web-enabled telephone 50 or other wireless device. In this case, the transmitting device may be operatively coupled to the query and answer system 10 via an XML processor or similar application 52, which may reside in the query and answer system.

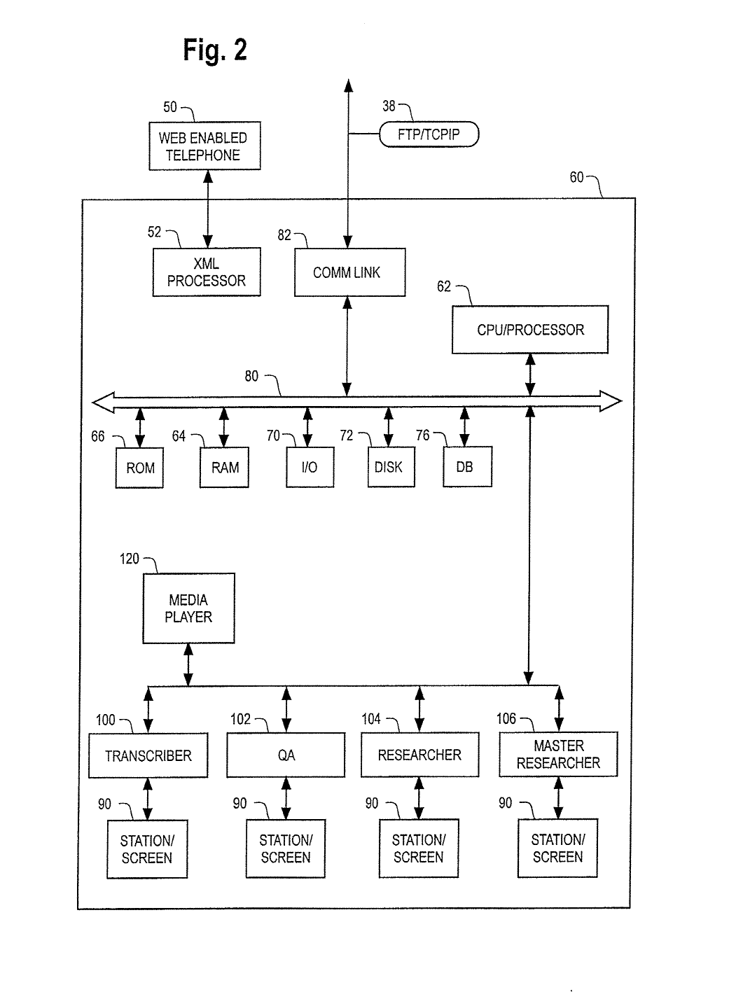

The query and answer system 10 may be implemented on a standard computer platform. The query and answer system preferably includes a computer system 60, which may be in the form of a desktop, laptop, or notebook style personal computer, such as an IBM® or APPLE® brand compatible personal computer (shown most clearly in FIG. 2). Preferably, the computer system 60 is an IBM® brand compatible personal computer, having for example, one or more microprocessors 62 running under WINDOWS, UNIX, Linux, or any other suitable operating system. The computer, however, may be any computer, processor, central processing unit (CPU), microprocessor, RISC (reduced instruction set computer), mainframe computer, work station, single chip computer, distributed processor, server, controller, micro-controller, discrete logic device, remote computer, Internet computer or web computer.

The computer system 60 may include known commercially available components, such as RAM 64 (random access memory), ROM 66 (read only memory), input/output ports 70, disc storage 72, database 76 and applications, and the like. As is known in the art, the various components of the computer system are coupled to each other via one or more standard computer buses 80. Of course, multiple computers or multiple computer systems may be used to handle the processing and to distribute the processing load without departing from the scope and spirit of the invention. Also included are multiple screens or work stations 90 for the operators or attendants.

Preferably, the query and answer system 10 includes a communication link 82 to operatively couple the computer system 60 to external devices via FTP using TCPIP protocol, as is known in the art. The query and answer system 10 may also include one or more internal databases 76 (FIG. 2) or external databases 86 (FIG. 1).

In one specific embodiment, the query and answer system 10 is preferably operatively coupled to the voice mail system of the IVR/VR 24, and is configured to receive a recorded voice message from a customer. Using the wireless telephone 18, the customer or user may dial a specific telephone number to reach the query and answer system 10. IVR/VR device 24 may prompt the customer to select various options in accordance with a menu selection. After the customer has selected the appropriate menu choice, he may state the pertinent question, which may be recorded and digitized, and stored in a voice mail box or other storage medium in the IVR/VR.

The caller may also pose his question via email, which email message may be received by the email server 44. The email may be parsed and appended into a SQL table 94 (Structured Query Language), in which an indication is set informing the system that this query has not yet been answered. The Structured Query Language may be written in Microsoft SQL Server 2000 or any other language adaptable to such tasks.

A web services application referred to as the “auto-distribution” 98 or the “auto-distribution sub-system” may run as a background program on the web-server. This application may be written utilizing Microsoft .NET Technology, Version 1.1 or any other language adaptable to such tasks. The auto-distribution sub-system 98 may be operatively coupled to a transcription sub-system 100, a quality assurance (QA) sub-system 102, a research sub-system 104, and a master research sub-system 106. The above mentioned sub-systems may be software applications written utilizing Microsoft NET Technology, Version 1.1 or any other language adaptable to such tasks.

The auto-distribution sub-system 98 may query the email server 44 to obtain the email questions. To accomplish this, a polling application, referred to as “get-mail” 110 is preferably running in the background on the web-server 46, which is operatively coupled to the email server. The get-mail application 110 may poll the various mail boxes to obtain the questions posed by the customers, whether in the form of voice mail from the IVR/VR 24 or in the form of email from the web-sever 46. Preferably, the get-mail application 110 polls the email server 44 and/or the IVR/VR 24 only when there are a minimum number of messages or questions stored in a queue 94. For example, when the queue 94 has been depleted so that only thirty messages remain, for example, the get-mail application may perform the polling process to obtain additional messages with which to populate the queue. Alternatively, if no additional messages are waiting to be serviced, polling may be suspended for a predetermined period of time, for example, three minutes, thereby saving system resources.

The get-mail application 110 may then forward the question to the auto-distribution sub-system 98 for further routing to the various stations or operators, namely, the transcriber station or operator 100, the quality assurance station (QA) or operator 102, the research station or operator 104, and the master research station or operator 106. The get-mail application may be written utilizing Microsoft .NET Technology, Version 1.1 or any other language adaptable to such tasks.

Preferably each operator or station (i.e, transcriber, quality assurance, research and master research) initiates distribution of a question via clicking of a “get question” button or icon on the operator's display screen 90. A request is then made to the auto-distribution sub-system 98 to retrieve a question from the queue 94 and distribute it to the requesting operator. Preferably, the question is stored in an operator queue corresponding to each type of operator. Thus, a transcriber queue 116, a QA queue 118, a researcher queue 120, and a master researcher queue 122 are provided for the corresponding operators. The auto-distribution sub-system 90 provides two functions. First, the auto-distribution sub-system 90 may receive a request from the station or operator and immediately query the email server 44 for messages (questions) that have populated the in-box. These questions may then be parsed into a readable format, which may be appended into the “general queue” SQL table 94. Second, the auto-distribution sub-system 98 may receive a request from the transcriber station 100 and immediately query an FTP directory for voice mail questions in the form of a WAV file. These questions are then assigned an identifier or key ID, which may be appended into the general queue SQL table 94.

If the customer poses the question via a web-enabled telephone 50, the telephone may be operatively coupled directly to the XML processing application 52 residing on the query and answer system 10. The XML processor application 52 may be written utilizing Microsoft .NET Technology, Version 1.1 or any other language adaptable to such tasks.

Regardless of the type of device used by the customer to communicate with the query and answer system 10, the question is handled by the auto-distribution sub-system 98. Again, such questions or customer queries may be in the form of a WAV file, an email, an XML data string or other text format.

In an alternate embodiment, rather that the operator stations (100, 102, 104, 106) requesting a question or query from the auto-distribution sub-system 98, the auto-distribution may deliver the questions to the stations without a specific request, based on certain criteria. The auto-distribution sub-system may poll the various stations, such as the transcription station 100, the research station 102, the quality assurance (QA) station 104, and the master research station 106, to determine resource availability. The auto-distribution sub-system 98 may determine which operators are logged into the system, which operators are idle, and which operators are available to handle the queries at their respective station, and may deliver the queries to the various stations based on longest idle time, or other suitable criteria.

In the case where the customer communicates using a voice-based device, such as a cellular telephone 18, a WAV file is created and stored by the IVR/VR 24. The WAV file can be in a template format or in a “free form” format. With template files, the form of the question dictates certain information to be included in the template. On the other hand, free form questions are not suitable for a fixed format template, and thus are interpreted and researched by a human operator.

Regarding template-suitable questions, for example, thirteen categories of questions may be provided, which represent commonly asked questions, such as category 1 for “weather,” category 2 for “stocks”, and the like. Any suitable number or identifier may be assigned to the particular categories. If the customer's question can easily fit into a particular category of questions provided by the system, the user may select this category type in response to prompts provided by the IVR/VR 24 in accordance with a menu selection. For example, the IVR/VR 24 may direct the customer to type or say the number 1 if his question is a weather related question, or type or say the number 2 if the question is a stock related question, and the like. If no standard category is suitable, the user can select a “free form” category, which may be, for example, category number 14, as will be described later. However, any suitable number of categories may be provided.

The following list illustrates some of the possible categories which may be presented to the customer by the IVR/VR 24. The list may be ordered according to the known frequency of such questions asked by callers. Of course, this is not an exhaustive list, and any suitable or practical number of categories may be provided, as follows:

1. Weather

2. Stock Quote

3. Sports Scores

4. Directory Assistance

5. Directions

6. Horoscope

7. Restaurants

8. Flights—Fares

9. Flights—Arrival & Dep. Info

10. Accommodations

11. Movie Timetables

12. Comparison Shopping

13. Vegas Odds

14. Free Form Questions

It will be understood by persons having ordinary skill in the art that a user may choose a natural spoken language to make a query as well, without departing from the novel scope of the present invention.

Preferably, the file name of the WAV file incorporates the category selected. In one specific embodiment, the first two digits of the file name of the WAV file reflects the category number. Accordingly, the file name of the digital recording of the caller's voice, that is, the WAV file of the digitized voice recording, may then reflect the selected category. For example, the name of the WAV file may begin with the digits 01 if the file represents a weather related query.

Additionally, when the user calls the query and answer system 10, the ANI (automatic number identification) field is interrogated to provide the system with the caller's telephone number (caller ID). The customer's telephone number may then be used to access the customer database 86 to locate the customer's account number. Preferably, the customer's account number also forms part of the WAV file name, and preferably follows the category identifier as part of the file name. For example, if the customer's telephone number is (312) 555-5555 and the question concerns weather, the WAV file may be assigned, for example, the file name of 013125555555.wav. Interrogation of the database corresponding to the customer account may determine if the user has paid the required fees.

After the WAV file has been assigned a name, it may then be sent to a particular transcriber 100 via the auto-distribution sub-system 98 for transcription by a human operator, either based on a request for question from the transcriber (via clicking of the get-question icon or button) or by criteria-based automatic forwarding of the message by the auto-distribution sub-system. The WAV file may be placed in the transcriber queue 116 for each selected transcriber via the auto-distribution system. The transcriber 100 may be informed of the arrival of the new question (i.e., new file) by a suitable audio sound or a visual alert presented on the transcriber's screen 90. Preferably, each transcriber 100 has his own queue 116. The transcriber queue 116 may be shown on the transcriber's monitor 90 in a suitable sequential order, preferably in FIFO order (first-in first-out or oldest on top) so that the oldest WAV files are serviced sooner. The transcriber 100 may then click on the icon representing the WAV file in the queue to listen to the digitized recording. Clicking on the icon representing the WAV file may activate an embedded WAV media player 120 running on operator's station system to permit the operator to listen to the contents of the WAV file. The WAV media player is a commercially available product, for example, Windows Media Player, version 10, by Microsoft. Preferably, the operator listens to the WAV file through a headphone set, but any suitable apparatus may be used.

In some situations, the caller's question may be unintelligible, either due to a poor telephonic connection or because the caller may not be speaking properly or cannot be otherwise understood by the transcriber 100. In such an event, the transcriber 100 may enter an error code so that the file will be sent to the quality assurance (“QA”) operator 102 for further processing. The QA operator will know that the transcriber was not able to discern the question based on the error code. Accordingly, the QA operator 102 may verify this condition by similarly reviewing the WAV file, and if he agrees that the question was not discernable, the QA operator may click a button that provides an automatic response to the caller informing the caller to call back and repeat his query. Alternatively, the QA operator 102 may be able to discern the question that the transcriber was not able to discern, and if so, the QA operator may finish the transcription at the QA station. Note that the QA operator 102 may perform spot-checks on the work product of the transcriber, and generally need not review every transcription. However, the QA operator preferably reviews all transcriptions for which the transcriber 100 has set the error code.

Obviously, if the customer is communicating using a non-voice based device, such as by email or a web-enable telephone, no voice message is recorded and no WAV file is created. However, the text-based messages transmitted by the customer and handled by the auto-distribution sub-system may nonetheless be forwarded to the transcription operator 100 to effectively “clean up” or otherwise edit and improve the content of the text query.

Note that when the WAV file or other text-based file is directed to the transcription station 100, it is preferably routed to the transcriber having the longest idle time. However, any suitable method of determining routing may be used, as will be described in greater detail hereinafter.

Because the name given to the WAV file or other text-based file may include the category of the customer query, clicking on the file by the operator may invoke some automatic action based on that category. The template corresponding to the selected category may provide a particular GUI (graphic user interface) to the operator, which may, for example, include entry or dialog boxes. For example, most weather related queries are based on the zip code to identify the geographical area to which the customer's weather question pertains. Thus, the template may provide an entry box into which the transcriber enters the zip code. Once the specific template is filled in by the transcriber, the transcriber may click a “send button” which forwards the template to the QA station or operator, as will be described later.

Regarding the underlying structure for the template, preferably, the data and template are XML based, thus it is relatively universal in nature, which permits the query to be “understood” by a content provider.

The following list illustrates some of the templates and sub-templates corresponding to the various categories mentioned above. The items listed in bullet-point format represent the entry or dialog box to be filled in by the transcriber during review of the WAV file. Of course, the list is not an exhaustive list, and any suitable or practical number of templates may be provided. Note also that the templates may be context sensitive and may provide “drill-down” levels of data. For example, if the customer selects category no. 7 (“restaurants”), further options may be presented to the customer, such as a choice of multiple cuisines (not shown in further detail).

1. Weather
City—10 digits
State—2 digits
Zip—5 digits

2. Stock Quote
Symbol—4 digits
Company Name—10 digit

3. Sports Scores
A. Professional
   League—Choose NBA/NFL/MLB/NHL
   City or Location—15 digits
   Team Name—10 digits or team name
   Game Date
   Retain favorite team settings
B. College
   Sport—10 digits—Football & Basketball
   Mens/Womens
   College/University Name—15 digits
   Game Date
   Retain Favorite team settings

4. Directory Assistance—411.com
First Name
Last Name
Street Number
Street Name
City
State
Zip

5. Directions—maps.com
A. From
   Street Number
   Street Name
   City
   State
   Zip
B. To
   Street Number
   Street Name
   City
   State
   Zip

6. Horoscope—astrology.com
Birthdate—day
Birthdate—mo
Birthdate—year

7. Restaurants
Type of cuisine (choose from drop down menus)
City
State
Country (if other than US or Canada)
zip/postal

8. Flights—lowest available ticket prices
Round Trip or One Way
Departure city
Departure State
Or Departure Airport
Arrival city
Arrival State
Or Arrival Airport
Date departing
Time departing (enter time or choose “anytime”)
Date returning (enter time or choose “anytime”)

9. Flights—Arrival times, should also do departure info
Flight number
Airline
Departure Airport
Arrival Airport
Date

10. Accommodations—Names of hotels/motels and pricing
City
State
Or zip code
Check-in date
Nights of stay (or check out date)
Rate options (i.e.,—under $100, under $250, under $400, no limit)

11. Movie Timetables
Name of theatre; or
City
State
Or zip code
Name of movies; or all movies
Date

12. Comparison Shopping—On-line merchants
Name of Product and model number

13. Las Vegas Odds
A. Professional
   League—Choose NBA/NFL/MLB/NHL
   City or Location—15 digits
   Team Name—10 digits or list all teams to choose from
   Game Date
   Retain Favorite team settings
C. College
   Sport—10 digits—Football & Basketball
   Mens
   College/University Name—15 digits
   Be able to retain ‘Favorite’ team settings
D. Horse Racing Track Odds

14. Free Form Questions
50 characters maximum

The quality assurance operator 102 may review the WAV file (or other file) and the data entered by the transcriber to determine if all of the data appears to be correct, and thus verifies the accuracy of the transcribed question. If the data appears to be correct, the QA operator may click a button to cause the template to be sent to an automatic content provider. Note that with such template based questions, no human researcher is needed to find the answer, as contrasted with the process used with free-form questions. With respect to the prior example of a caller requesting weather related data, in this situation, the QA operator would review the template for the question posed, and if verified, would send the weather related query to the content provider. Such content providers may include: AccuWeather.com, API411, SportsDirect, FlyteSource, Money.net, Hotels.com, Maps.com, SportsNetwork.com and the like. The answer provided by the content provider may then be automatically sent back to the caller via the same medium that the user posed the question, which in the above example, may be the customer's mobile device, such as a cellular telephone or PDA (personal digital assistant). Note that the transcribed question, which may be edited by the QA operator 102, and the corresponding answer when received, may be saved to a master question/answer text table 126, for example, once per day, so as to maintain a complete historical record of all transactions.

Note that the QA operator 102 need not evaluate every transcribed question. Rather, the QA operator may perform a “spot check,” especially if the transcriber is inexperienced, is a trainee, or has a poor performance record. The results of the QA operator's review may also be maintained in an error table 130 so that corrective action, if needed, may be taken.

As mentioned above, the answer to the caller's question may be transmitted back to the caller via the same communication device used by the caller used to transmit the question. Thus, in one embodiment, the question may enter the system as a voice mail or spoken message, but the answer may be returned to the customer as a text answer transmitted to the customer's cellular telephone. Of course, this assumes that the customer's cellular telephone is capable of displaying text or other graphic messages. In another embodiment, the question may enter the system as a text message (SMS or email), and thus, the answer may be returned to the customer as a text answer. In either embodiment, the question is routed via the auto-distribution sub-system, to the transcriber station 100, the researcher station 104 if a free-from question, the master research station 106 if needed, and to the quality assurance station 102, on a spot-check basis.

As mentioned above, the WAV file may be in a template format or a “free-form” format. Free form questions are questions that do not conveniently fit into a specific template, and may be treated more like a “trivia” question. For example, the customer may call the query and answer system 10 and pose the following question: “what was the birth state of the 14^{th} president of the United States.” Again, as above, the WAV file may be sent to the transcriber for human transcription. These types of queries are preferably answered by a human researcher, and not automatically by the content provider due to their nature and level of difficulty. As is similar to template-suitable questions described above, the free-form question is also transcribed by the transcription operator 100 and may be spot-checked by the QA operator 102 for verification and accuracy. As mentioned in the above example, the file name of the WAV file may begin with the digits 14 to indicate that it is a free-form question rather than a template based question.

Once the transcription of the question is complete, or has been verified by the QA operator if spot-checked, it may then be forwarded to the research queue 120 via the auto-distribution sub-system 98 so that a human operator may research the question to obtain a suitable answer.

Preferably, for free form categories, the transcriber 100 can use his judgment and assign a free-form category, if applicable, to the question. This may be done for very frequently asked classes of free-form questions, and a popularity identifier may be assigned to such questions. For example, the transcriber may recognize that the query is certainly a free form question, but may also recognize that it is a sports, history, or travel question, which are commonly asked questions. This permits routing the question to a particular researcher 104 who may be more efficient because the particular researcher may have some expertise in this area. For example, a particular researcher may be a sports trivia expert, who can more quickly obtain the answer to the query. Preferably, that particular researcher will receive the majority of the sports related free form questions.

After a particular WAV file representing a free form question has been transcribed, the transcribed question or query may be sent to the research queue 120. The transcribed free form query may be routed to the “researcher” on a “First Come-First Serve” methodology. All stations (Transcriber, Researcher, QA) preferable include the “get-question” button or icon on their display screen 90, that when clicked on, will trigger the events described above regarding the auto-distribution sub-system and the get-mail application. The question or query forwarded to the researcher includes all of the parameters used to populate the display screen or workstation screen. Preferably, a “first-come first-serve” methodology is used, but any suitable methodology may be used, such as a “strength of category” ranking, which accounts for particular knowledge strengths by the individual researcher. Each research operator may be graded on their accuracy and speed of each question answered, and this grade or value may be assigned a ranking per category.

As described above, in one specific embodiment, when the researcher 104 is available to service a question in his queue 120, the researcher may then click on the icon on his screen representing the transcribed query (i.e., the WAV file) residing in the research queue. The text of the transcribed query may then be displayed to the researcher. The researcher may then begin to perform research to obtain an answer to the question. Any research tool may be made available to the researcher. Preferably, as a first step, the researcher may enter the query, or his interpretation of the query, into a search engine, such as for example, GOOGLE® or YAHOO®. However, any number of tools, such as commercially available databases or knowledge-bases may be available to the researcher depending upon the depth and comprehensiveness of the particular installation. For example, the researcher 104 may have access to Lexis/Nexus® for researching legal issues. There is essentially no limitation on the number or types of research forums available to the researcher, within the constraints of time and money.

Once the researcher finds the appropriate answer to the customer's question, the researcher may “cut and paste” the results obtained and forward such text back to the customer. Alternately, if the results of the research are not presented to the researcher in a form suitable for sending back “verbatim” to the user, the researcher may paraphrase or prepare a written response in his own words, and then send that response back to the caller.

Note that the QA operator 100 may perform a “spot-check” to evaluate some of the answered questions to determine if the researcher is performing in an acceptable manner. If the QA operator 100 determines that a question has been answered incorrectly by the researcher, the question may be redirected to the master researcher 106, who may be particularly skilled in certain subject matters. Accordingly, the question may be routed to the master researcher queue 122 via the auto-distribution sub-system 98 to handle the question.

Again, the question, answer, an indication that an answer was incorrect, and the corrected answer, may all be stored in the database 86 in the form of the maintained error table 130 so that corrective action, if needed, may be taken. Such error table entries may include pertinent information, such as the identity of the employee or operator handling the question (i.e., the transcriber or the researcher), the category of the question and the question identification (i.e., the file name).

Further, the researcher may send a particularly difficult question to the master researcher if, for example, he cannot obtain a satisfactory answer within a specific period of time, for example, three minutes. In some unusual situations, even the master researcher may not be able to obtain an answer to the question. If this situation arises, the master researcher may reply to the caller with an answer that after an exhaustive search, a suitable answer to the question cannot be found.

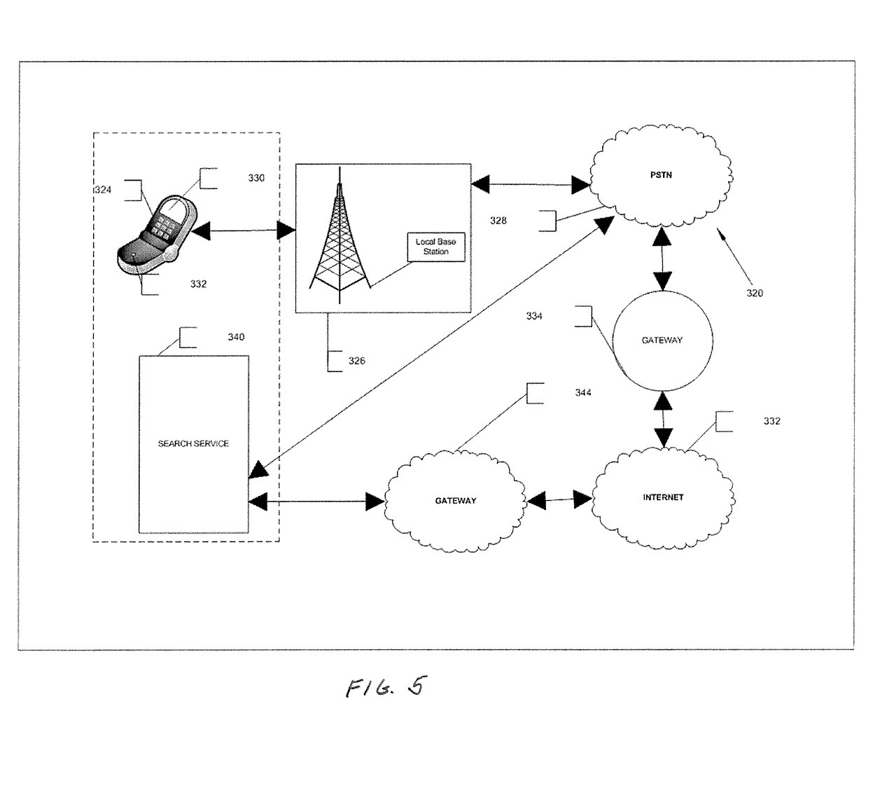

Referring now to FIG. 4, as generally indicated, files representing the customer query are retrieved by the get-mail application (step 200) and forwarded to the appropriate station. If the file or question is a template based question 202, it may be forwarded to an automatic content provider (step 204). Otherwise, it is a template based question, and may be forwarded to the transcriber station (step 206). After the question has been transcribed, it may be spot-checked by the QA operator (step 208) and forwarded to the researcher (step 210). Again, the results of the researcher may also be spot-checked by the QA operator (step 212). If the answer provided by the researcher is spot-checked and approved (step 220), it may be sent to the customer (step 222) via the communication device that the customer used to pose the question. If the QA operator or the researcher determines that a satisfactory answer has not been issued, the question may be sent to the master researcher (step 224). The master researcher may then either provide a suitable answer, or respond that an answer cannot be obtained. This process is repeated and the system then checks to see if additional questions need to be answered (step 226).

To enhance revenue, a caller may be sent promotional or sales material for various products, much like a targeted marketing program. The seller of such products or services may then be charged a fee for each candidate customer to whom the promotional information is sent. Alternately, the caller may be charged a fee for the questions asked, either on a flat fee basis, a timed basis, such as a fee per month, or on a question-by-question basis, perhaps with some maximum number of questions for a specific fee.

In another specific embodiment, the caller may be sent a “contextual advertisement” along with each answer provided to the user. The advertisement is said to be contextual because it may be relevant to the particular question initially posed by the caller. For example, if a caller poses a sports related question, the caller may receive along with the answer, an advertisement encouraging the caller to subscribe to a sports magazine. This could be based on each specific question or it may be based on the caller's established question history or trend. If the question or call history of a particular caller indicates that many of his questions involve housing, perhaps mortgage brokerage contextual advertisements may be sent to that caller. Of course, this assumes that the caller's communication device can receive and display text and/or graphics.

Another feature of the present invention permits a caller to send an email via a voice message where the caller may not have access to or may not be able to send an email through his particular device. For example, if the caller is using a standard cellular telephone that is not web-enabled and wishes to nonetheless transmit an email, he can accomplish this using the infrastructure of the present system. In this specific embodiment, the customer need only place a voice telephone call to the query and answer system 10 and select the option presented by the IVR/VR of sending an email via “voice transcription.” Once the selection has been made, the caller may then “speak” the contents of the email message desired to be sent. Preferably, the caller would also dictate the email address to which to send the email. The voice file would then be digitized into a WAV file in a similar way that the questions are digitized into a WAV file, and the file may then be transcribed into text by the transcribing station. The transcriber, of course, would be able to recognize that this is a special class of message, rather than a question, and would transcribe the message from the WAV file, and then cause it to be sent to the email address requested by the user. This is essentially a special “service” provided by the system. Again, the QA operator may spot-check such special requests in a similar way in which the question transcriptions are spot-checked.

In an alternate embodiment, some questions may be able to by-pass the auto-distribution system, and hence by-pass the transcription station, research system, and the like. For example, a mail text question may be sent to the question and answer system by a caller through a BLACKBERRY® wireless device, which may have the template-based JAVA application or “applet,” which may reside on the wireless device. In this situation, a template may be presented to the user, and the user may fill in the category corresponding to the question. Accordingly, the question may be sent to the system in an email format. The question and answer system may then determine that the incoming call originated from a wireless device in template format and may automatically route the call to a content provider to automatically provide the answer to the caller without human intervention. Data validation may be added to the applet residing on the caller's device to insure that the data entered by the user will be understood by the system.

Turning now to FIGS. 5-8, as an overview, the subject invention 300 of these figures may be used in conjunction with the search service (answer provider) or content engine described above with respect to FIGS. 1-4. For purposes of the invention of FIGS. 5-8, the search service is the organization or “content engine” that provides an “answer” to the user's question. The user may contact the search service by cellular telephone, mobile device or other suitable communication equipment using SMS, mobile email (such as that provided by Blackberry® service) or other applications (email or SMS push). Alternatively, the user may speak to a human operator at the search service, or may send a text message to the search service (via SMS, for example) representing his or her query. The query may be in a natural language format or in a formatted or template type model.

To support the financial model for such a service, the search service preferably provides the user with an advertisement along with the answer to the user-posed question to facilitate e-commerce and enhanced revenue generation based on placement of the advertising. Alternatively, the user may be charged a fee for using the service. The search service, may be, for example, AskMeNow, a mobile lifestyle company located at 26 Executive Park, Suite 250, Irvine, Calif. The user may contact AskMeNow via cellular telephone by dialing 26563 (A-S-K-M-E).

As described herein, the specific embodiments of the above-described search service disclose the way in which the search service may provide the “answer” or content to the user's query, which query and associated answer are essentially unlimited in scope. But often, such queries pertain to 411 listings, weather, movie schedules, sports scores, financial quotations, horoscopes, travel information, and the like.

Note that the search service used in conjunction with the subject invention need not be the same as the search service described in the embodiments of FIGS. 1-4, and any suitable search service or search provider or organization may be used. For example, the search service may not necessarily include the feature of transcribing the query by an operator or any other of the features described above, or any other specific features described herein, and still remain within the scope and spirit of the subject invention. The search service need only provide an answer to the user query by any suitable mechanism or method, whether by fully computerized or by automatic means or by using human intervention and assistance, along with the integrated advertisement.

Referring now to FIG. 5, a high-level block diagram of a communication system in conjunction with the present invention is shown generally as 320. A user having a cellular telephone 324 or other mobile communication device communicates with a cellular telephone tower and local base station 326, as is known in the art, in any suitable communication format. The cellular or mobile communication device 324 includes a display screen 330 and a wireless application protocol (WAP) enabled interface (or application) 332 configured to facilitate the display of graphics on the display screen. The WAP interface 332 may be a built-in software application or may be downloaded from an alternate source. The WAP interface 332 may also be configured in hardware and/or may be built into the communication device 324. As is known, the local base station 326 may communicate through the public service telephone network 328 (PSTN), which in turn is in communication with the Internet 332 via a gateway 334. A search service 340 may also communicate with the Internet 332 through its gateway 344.

The system 300 facilitates enhanced advertising revenue in a mobile communications environment because the advertisers are willing to pay greater fees for advertisement placement because it is believed such advertisement will be viewed and seen favorably by the user. Because the subject invention uses a WAP enabled communication device 324, the problem of truncation of the answer is eliminated and graphic indicia are able to be displayed. Further, because the graphic or advertising indicia is integrated or coupled with the answer to the user's query, the user has virtually no choice but to view the advertising indicia when accessing or reading the answer to the query provided by the search service 340.

Advertisers or sponsors understand that in such a system the user is motivated to view the answer to his or her question, thus they acknowledge that the user will most likely view the advertisement. Because the goal of the advertiser is to motivate the user to view the advertisement, such advertisers are willing to pay higher placement fees because such user viewing of the advertisement is enhanced. Accordingly, the present invention facilitates a very high click through rate, and thus high advertisement revenue may be generated by such placement of advertisements on the mobile communication device 324.

In operation, the advertisements are integrated into or coupled with a searched answer yielding specific and relevant answers from a natural language or keyword search criteria or query. The answer may be delivered to the user's cell phone or other mobile device 324 via SMS, email, MMS (multimedia messaging service) or an IP (Internet Protocol) connection. The answer and sponsored advertisement is rendered within the WAP enabled display device 324, MMS or HTML link. The user or subscriber clicks on the link to read the answer provided by the search service 340, and the link opens automatically or an MMS opens and shows the graphical answer and graphical advertisements. This facilitates the highest click through rate (or response to get more information) because the incentive to click through to the graphical answer is the high value answer itself. The answer could also be integrated with a short audio or video clip of the advertisement.

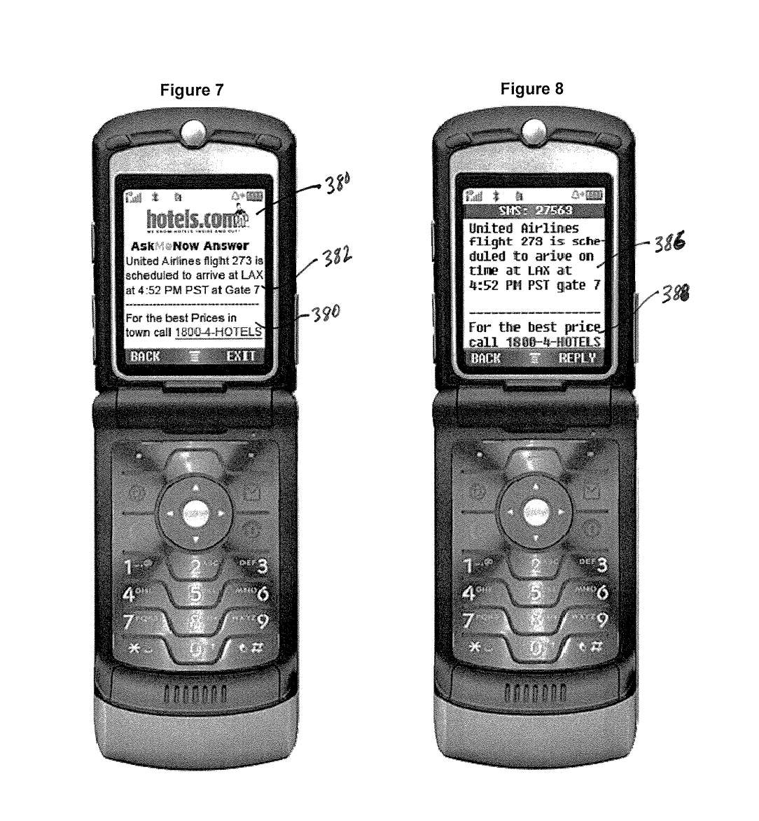

Referring now to FIG. 6, a process flow is shown. At a step 350, the user may pose a query to the search service, either by placing a telephone call, as shown in a step 352, or by using text messaging, as shown in a step 354, as the search service 340 is configured to handle any and all queries from users. The query is then directed to the various servers at the search service, as shown in a step 356, and a database lookup is performed, as shown in a step 360 to determine if the caller's telephone or mobile device is a WAP enabled device. If the mobile device is WAP-enabled, as shown in step 364, the search service searches for the answer to the query posed as shown in step 370. A detailed answer is then provided, including graphics, because such WAP enabled devices provide much greater display capabilities, as shown in a step 374.

Once a suitable answer is found, either by human operators/search investigators, by automated means based on key word and the like, or by a combination of both, the answer is then integrated with relevant advertising indicia, as shown in a step 376. One feature of the present system is that relevant advertising is paired with the answer. Accordingly, the response to the user includes the answer to the query, which is strategically paired with the advertising indicia such that there is a relevant relationship between query and the advertising indicia. For example, if the user's query is directed to finding a hotel in a certain area, not only might hotel advertising be presented to the user, but rental car advertising may also be included as well in the integrated response.

Because advertising sponsors understand that the paired advertising is relevant to the query and that the user is motivated to view the answer, and hence, as a consequence, the advertisement itself, such advertisers are willing to support the business model by paying higher fees for such advertisement placement. The response to the user query consisting of the answer and relevant advertising indicia is then shown on the user's display screen in an integrated format, meaning a single viewable format, such as a single display image. However, this does not mean that only a single display image can be provided in addition to the image containing the answer and advertisement. For example, a further link may be provided in the display image, which if clicked, would provide further display images.

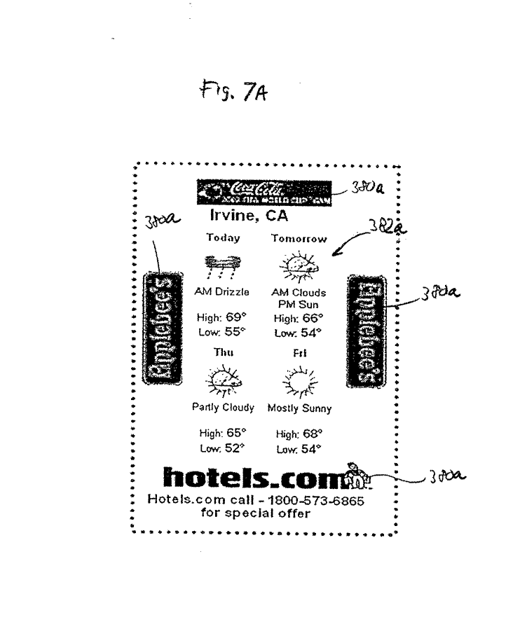

In one specific embodiment, the screen display corresponding to the paired answer and advertisement may appear as shown in FIG. 7. In this specific example, the user query may have related to a weather report for Irvine, Calif. Because the search service may have detected that the user was from out of the area, the context of the query resulted in placement of restaurants and hotel advertising in the Irvine area. Accordingly, the user must view the advertisement 380 to read the content of the answer, namely, the requested weather report 382. As shown, the advertising indicia 380 in the form of graphics and logos, is placed attractively around the answer provided. Virtually any form of graphic or multimedia information can be displayed on the WAP-enabled device, such as banners and the like, to create a much richer creative advertising result. The advertisement may also include additional clickable links to another WAP activation page or clickable telephone number. Such placement of advertising indicia supports enhanced revenue from sponsors.

Contrast the above to the unimpressive results using known systems where a standard mobile device is used, as shown in FIG. 8. In this figure, the results of the query, again the weather report 386 in this example, is paired with a textural response regarding hotels 388. Aside from the limited character length available in this SMS format, the advertisement is not particularly compelling, and has been shown to be relatively ineffective with respect to user response or click-throughs. Accordingly, advertising sponsors are not willing to pay higher fees for such advertising placement.

For completeness, the process flow resulting in the display of FIG. 8 is further shown in FIG. 6, which may be used in conjunction with the search service, although this model may not support the enhanced revenue described herein. Returning back to a step 400 of FIG. 6, if the mobile device is not WAP enabled, an answer to the question is still searched, as shown in a step 402, but a limited or short text answer is provided, as shown in a step 406. Next, the advertisement is paired with the answer, as shown in a step 410, but in this situation, it is limited to a text message, which may be limited to 70 characters, or at most 160 characters. However, such advertising does not command a very high revenue, because the user is not motivated to view the advertisement due to its inferior format.

One difference between the present invention of FIGS. 5-7 and known systems is the ease of use for the user. Rather than downloading an application or navigating through multiple pages of slow web browsers, the user may submit the information requests in the simplest of format, which they are already accustomed to using, for example by calling in or by using SMS/Email or IVR/VR. Additionally, the present invention allows users to query for the information they desire through natural language as they would commonly speak or type in such requests through pre-set formatted text, depending upon the user's device and preferences. The answers are returned via SMS/Email with a one-click link to a mobile WAP/HTML or MMS page containing the full answer along with the paired relevant advertising indicia.

Another feature of the present invention is the superior quality of information provided to the user. Instead of only returning 160 characters of plain text, or less, as is the case with known systems, the information desired is returned in whole form complete with graphics, images, and any needed multimedia. For example, video or sound sequences or clips may also be provided to the user via the mobile device. Such a system offers significant business advantages because it permits search providers to offer advertisers a superior medium for interacting with and marketing to the mobile user. Further, multiple advertising sponsors may be represented in a single answer/advertisement response, which can be seen in FIG. 7.

It will, therefore be understood that the protocols used in a method of presenting a query in the present invention can: use a browser based on IP or HTML or WAP; email; SMS such as text messaging and IVR/VR such as telephone calls (wireless or land-lines); and then return a response to the query based on any one of the above as is determined is the best manner of responding based on the equipment used. Further, the system can include a self configuring personal browser page containing the answer and the relevant advertisement(s), where the individual parameters are stored in a table and once retrieved, the page is dynamically and automatically created. Broadly, the invention in one embodiment includes: 1) Answer is displayed in a browser page; 2) Relevant advertising is incorporated in the answer displayed in a browser page; 3) The user must view the advertisement to read the answer displayed in a browser page; 4) The system understands the question via semantic understanding using either humans responding or computer (software and hardware) based responses. The system of the present invention greatly transcends traditional keyword search, as the system of the present invention can understand the question it can then automatically add the highest (best) matched advertisement(s) to that user answer, therefore, generating the highest possible value to the marketer, hence the highest paid advertisement or CPM.

Specific embodiments of a method and apparatus for presentation of content and advertising in a WAP enabled mobile device according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A system for enhancing advertising revenue in a communications environment, the system comprising:
A user operated communications device;
a search service configured to receive a query in natural language from the communication device;
the search service using natural language to provide a specific answer or response to the query from the user via the communication device; and
the specific answer or response including an answer to the user query integrated with one or more relevant advertisement(s) specifically related to the natural language query.

2. The system according to claim 1, wherein the advertisement includes graphic information.

3. The system according to claim 2, wherein presentation of the graphic information to the user facilitates user interest and supports a high CPM (cost per thousand views).

4. The system according to claim 1, wherein the communication device includes devices using SMS, voice, Internet, wireless Internet, IP or mobile email.

5. The system according to claim 1, wherein the answer provided to the user is paired with one or more advertisements that is relevant to the answer so as to increase user interest.

6. The system according to claim 5, wherein the pairing of the one or more advertisements with the answer is based on the specific content of the user query.

7. The system according to claim 5, wherein the increased user interest is directly related to the higher CPM (cost per thousand views) paid by the advertisers sponsoring the advertisement.

8. The system according to claim 1, wherein the one or more advertisements includes a logo corresponding to the advertiser.

9. The system according to claim 1, wherein the one or more advertisements is integrated with the answer based on keywords contained in the query.

10. The system according to claim 1, wherein the one or more advertisements is integrated with the answer based on one or more categories associated with the query.

11. The system according to claim 1, wherein the one or more advertisements is integrated with the answer based on user information from the query.

12. The system according to claim 1, wherein the one or more advertisements is multimedia based.

13. The system according to claim 1, wherein the multimedia includes video or audio sequences or clips.

14. The system according to claim 1, wherein one or more advertisements from more than one advertising sponsor is paired with the answer.

15. A system for enhancing advertising revenue in a mobile communications environment, the system comprising:
a mobile communications device having a display screen and wireless internet access via wireless application protocol (WAP) or other wireless internet enabled interface configured to facilitate the display of graphics on the display screen;
a search service configured to receive a natural language (NLP) or keyword query from a user via the mobile device;
in response to the user query, the search service providing a response to the user on the mobile device, the response integrating an answer to the user query with relevant one or more advertisements in a single display image, said one or more advertisements including graphic or multimedia information; and
wherein the presentation of the graphic and/or multimedia information to the user supports a high CPM (cost per thousand views) paid by advertisers sponsoring the advertisement.

16. The system according to claim 15, wherein presentation of the graphic information to the user facilitates user interest and supports a high CPM (cost per thousand views).

17. The system according to claim 16, wherein the mobile device submits the query by SMS, IVR/VR, or mobile email.

18. The system according to claim 1, wherein the answer provided to the user is paired with one or more advertisements that is relevant to the answer to increase user interest.

19. The system according to claim 15, wherein the one or more advertisements includes a logo corresponding to the advertiser.

20. A method for enhancing advertising revenue in a mobile communications environment, the method comprising:
providing a search service configured to receive a natural language (NLP) or keyword query from a user, the user transmitting the query via a mobile communication device having a display screen and wireless internet access via wireless application protocol (WAP) or other wireless internet enabled interface configured to facilitate the display of graphics on the display screen;
the search service providing the answer to the query;
integrating the answer to the user query with relevant one or more advertisements, the advertisements including graphics and/or multimedia; and
transmitting the integrated answer and advertisement to the user for output on the user's communication device.
